(19) United States
(12) Patent Application Publication
(10) Pub. No.: US 2010/0281722 A1
(43) Pub. Date: Nov. 11, 2010

(54) PRINTING PROCESS

(75) Inventor: Jacko Hessing, Tilburg (NL)

Correspondence Address: BANNER & WITCOFF, LTD., 1100 13th STREET, N.W., SUITE 1200, WASHINGTON, DC, 20005-4051, US

(73) Assignee: FUJIFILM MANUFACTURING EUROPE B.V., Tilburg (NL)

(21) Appl. No.: 12/746,467

(22) PCT Filed: Dec. 3, 2008
(86) PCT No.: PCT/GB2008/003994

§ 371 Date: Jun. 7, 2010

(30) Foreign Application Priority Data
Dec. 4, 2007 (EP) 07023421.6

(51) Int. Cl. G09F 13/04; B41M 5/52; B41J 2/015

(52) U.S. Cl. 40/564; 428/32.13; 347/20

(57) ABSTRACT

A process for preparing an advertisement comprising printing an ink onto an ink receptive substrate, wherein the ink receptive substrate comprises a transparent or translucent support layer and a porous layer comprising polymerised monomers at least 30wt % of which monomers are alkylene glycol diacrylate(s) having an Mw below 500.

This invention relates to a process for printing visually attractive advertisements suitable for use both during the daytime and at night, e.g. for out-of-home advertising.

Visually stunning advertisements are crucial for the effective promotion of goods and services. Advertisements typically comprise text, pictures, artwork or a combination of these, designed to catch the eye of potential customers and persuade them to spend money with the advertiser. The market for attractive advertisements is enormous.

Stores advertise their existence in many ways, including the use of attractive, illuminated signage to entice passers by to enter and make purchases. Store windows often display pictorial representations of goods on sale and highlight special offers. Many fast food restaurants display menu boards, using a combination of text to describe the food and mouth-watering illustrations to tempt hungry customers.

Open areas such as underpasses, stations, airport lounges and shopping malls are prime locations for out-of-home advertisements. Phone booths and bus shelters increasingly have light box advertisements attached to them.

Digital displays using LCD, OLED and plasma screens are increasingly common for advertising in stores and airports. However these are expensive and unsuitable for areas where theft or vandalism are likely to occur. Also they are limited in size because larger screens are either too expensive or unavailable at the present time.

Some retail outlets, particularly fast food restaurants, require brilliant colours and fine outlines for their graphics, e.g. on fascia panels on frontages and menu boards. This can be difficult to achieve for the colours used to illustrate food items such as steak, hamburgers, croquettes, where various shades of brown are quite common.

In order to achieve brilliance and fine outlines the advertisement often needs a high transparency (to let more light through from behind, e.g. from a bulb or fluorescent light tube) and high whiteness (e.g. to take advantage of reflected light during daylight hours).

Whiteness is sometimes enhanced by including large amounts of white pigments, e.g. titanium dioxide, in the substrate carrying an advertisement. On the other hand, as the amount of white pigment is increased in the substrate, its transparency can fall, thereby reducing the brilliance when illuminated from behind at night time. Chemical bleaching is sometimes used to increase the whiteness of a substrate without increasing its pigment content, but that has environmental implications and in any case subsequent exposure to sunlight can cause unsightly yellowing of bleached materials.

While many out-of-home advertisements perform well under either daylight or night time conditions, it is not easy to provide advertisements which perform well under both sets of conditions. Sometimes two different images are prepared: one for daytime viewing and another for night time viewing. Other products require two times printing—on the front side as well as on the backside—to render an image that is acceptable at daytime as well as under reduced light conditions. Many of the current products used for both daytime and night time viewing have a low reflection density resulting in poor whiteness and low contrast which gives a dull impression.

We have now devised a process for printing visually attractive advertisements which provide a good balance of transparency and brightness and which is particularly useful where finely detailed images are required. These advertisements can be made in any desired size, show good day/night behaviour and are suitable even for areas where theft and vandalism tend to occur.

According to the present invention there is provided a process for preparing an advertisement comprising printing an ink onto an ink receptive substrate, wherein the ink receptive substrate comprises a transparent or translucent support layer and a porous layer comprising polymerised monomers at least 30 wt % of which monomers are alkylene glycol diacrylate(s) having an Mw below 500.

The alkylene glycol diacrylate may comprise groups in addition to the two acrylate groups and the residue of an alkylene glycol. Such additional groups, when present, are generally selected such that they do not have a significant adverse effect on the properties of the resultant ink receptive substrate. In one embodiment it is preferred that the alkylene glycol diacrylate is free from glycerol residues (e.g. free from —OCH₂CH(O—)CH₂O— groups). Preferably the alkylene glycol diacrylate consists of two acrylate groups and the residue of one or more alkylene glycol.

Mw is the weight average molecular weight. Mw may be determined by liquid chromatography-mass spectrometry, for example as described in the Examples below. The molecular weight information of monomers as supplied by most commercial suppliers is usually based on Gel Permeation Chromatography (GPC) which is less accurate and may yield different results.

Preferably the porous layer comprises polymerised monomers at least 40 wt %, more preferably at least 50 wt %, especially at least 60 wt % and more especially at least 75 wt % of which are alkylene glycol diacrylate(s) having an Mw below 500. In one embodiment all of the monomers in the porous layer are alkylene glycol diacrylates having an Mw below 500. Preferably the at least 30% of the alkylene glycol diacrylate(s) have an Mw below 450, more preferably below 400. These preference arise because the lower molecular weight species can give porous media having particularly good whiteness while still having an acceptable water solubility so can be used in combination with aqueous solvents. When the monomer is too hydrophobic a large amount of organic solvent is required to obtain a stable solution; therefore hydrophilic monomers are preferred. On the other hand when the monomer is too water soluble, upon polymerisation phase separation does not occur and the layer formed after polymerisation will not to be porous. Monomers with a high Mw tend to be less reactive and generally do not give the desired porous structure. High Mw can also lower the crosslinking density of the substrate, resulting in a weaker porous structure which in extreme cases may even collapse.

In a particularly preferred embodiment at least 75 wt % of the monomers are alkylene glycol diacrylate(s) having an Mw below 450, especially below 400.

In one embodiment the alkylene glycol diacrylate(s) having an Mw below 500 are of the Formula (I):

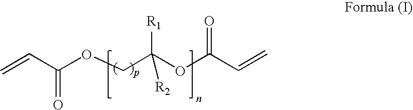

wherein:
each p independently is 1 to 5;

n is 1 to 8; and

each R₁ and R₂ in dependently is H, methyl or ethyl.

Preferred embodiments of compounds of Formula (I) are where any of the following rows of criteria are satisfied:

p is 1, R₁ and R₂ are H and n is 1 to 8;

p is 1, R₁ is methyl, R₂ is H and n is 1 to 6;

p is 1, R₁ is ethyl, R₂ is H and n is 1 to 5;

p is 2, R₁ and R₂ are H and n is 1 to 6;

p is 2, R₁ is methyl, R₂ is H and n is 1 to 5;

p is 3, R₁ and R₂ are H and n is 1 to 5; especially 1 to 3;

p is 4, R₁ is H or methyl, R₂ is H and n is 1 to 3;

p is 5, R₁ and R₂ are H and n is 1 to 3; and

p is 1, R₁ and R₂ are methyl and n is 1 to 3, especially 1.

Preferably p is 1 or 2.

Preferably R₂ is H and each R₁ independently is H or methyl.

Where high brightness is required n is preferably 1. Where cost effectiveness is a priority n is preferably 3 to 8.

A mixture of alkylene glycol diacrylate(s) of Formula (I) having different values for n may also be used.

Preferred alkylene glycol groups are of the formula —((C_{q}H_{2q})O)ᵣ— wherein q is 2, 3 or 4 (preferably 2) and r is from 1 to 8, more preferably 1 to 6, especially 1 to 4, more especially 1 or 2 and particularly 1. In a particularly preferred embodiment q is 2 and r is from 3 to 8. Relatively high values for r are preferred from safety point of view. Thus preferred alkylene glycol diacrylate(s) are of the formula H₂C═CHCO—O—(C_{q}H_{2q})O)ᵣ—COCH═CH₂ wherein q and r are as hereinbefore defined, with an Mw below 500, more preferably below 450, especially below 400.

Examples of suitable alkylene glycol diacrylate(s) include ethylene glycol diacrylate, di(ethylene glycol) diacrylate, tri(ethylene glycol) diacrylate, tetra(ethylene glycol) diacrylate, poly(ethylene glycol) diacrylate wherein the average number of ethylene glycol groups is 8 or less, di(propylene glycol) diacrylate, tri(propylene glycol) diacrylate, di(tetramethylene glycol) diacrylate, 1,3-butylene glycol diacrylate, 1,4-butanediol diacrylate, neopentyl glycol diacrylate, 1,6-hexanediol diacrylate and alkoxylated hexanediol diacrylate. Mixtures of these diacrylates may also be used. Commercial examples of suitable monomers are for example ethylene diacrylate (e.g. from AcrosOrganics, Belgium), triethylene glycol diacrylate (e.g. from Dayang Chemicals Co., China), tetra ethylene glycol diacrylate (e.g. from Leputech, China), polyethylene glycol 200 diacrylate (e.g. SR259 from Sartomer, France); poly tetramethylene glycol diacrylate (e.g. from Kyoeisha Chemical, Japan), dipropylene glycol diacrylate (e.g. SR508 from Sartomer, France), tripropylene glycol diacrylate (e.g. from Dayang Chemicals Co., China). In some cases the commercially available products are not a single pure compound but a mixture of compounds varying in number of alkylene glycol groups. Such mixtures are also suitable for use in the current invention provided at least 30 wt % of the monomers are alkylene glycol diacrylate(s) having an Mw below 500.

There is no particular limitation to the number of alkylene glycol diacrylates which may be included in the porous layer, although 1 to 10, especially 1 to 5 and more especially 1 or 2 are preferred.

Preferably the porous layer consists essentially of polymerised monomers at least 50 wt % of which are alkylene glycol diacrylate(s) having an Mw below 500, i.e. there is little else in the porous layer other than polymerised monomers.

Preferably the porous layer is in sheet form.

Any other monomers which are not alkylene glycol diacrylate(s) having an Mw below 500 will be selected so as to give the desired properties in the porous layer.

Such other monomers include, for example, alkylene glycol diacrylate(s) having an Mw of 500 or more, monomers and oligomers having one polymerisable group or more than two co-polymerisable groups (e.g. 3 or 4 (meth)acrylate groups). The amount of monomers having only one polymerisable group is kept low (e.g. below 5%) because these can weaken the porous structure since they do not contribute to the number of crosslinks. Typically the monomers will be selected to have a hydrophilicity or hydrophobicity to ensure the resultant growing polymer phase separates from the liquid medium to provide a porous layer. Preferably such other monomers are selected so as not to adversely affect the whiteness and porosity of the porous layer down to unacceptable levels.

In one embodiment up to 30 wt %, more preferably up to 25%, especially up to 20% of the monomers have three or more acrylate groups. In another embodiment none of the monomers have three or more acrylate groups.

Suitable (hydrophilic) other monomers having a good miscibility with water are: poly(ethylene glycol) di(meth)acrylates (MW>or =500), ethoxylated trimethylolpropane triacrylates, ethylene glycol epoxy dimethacrylate, poly(butylene glycol) epoxy diacrylate, ethoxylated bisphenol-A diacrylate (ethoxylation 3-10 mol), 2-hydroxyethyl acrylate, 2-hydroxypropylacrylate, 2-hydroxy-3-phenoxy propyl acrylate, 2-(ethoxyethoxyl)ethylacrylate, N,N′-(m)ethylene-bis(acrylamide), (meth)acrylic acid, (meth)acrylamide, 2-(dimethylamino)ethyl (meth)acrylate, 3-(dimethylamino)propyl (meth)acrylate, 2-(diethylamino)ethyl (meth)acrylate, 2-(dimethylamino)ethyl (meth)acrylamide, 3-(dimethylamino)propyl (meth)acrylamide, 2-(dimethylamino)ethyl (meth)acrylate quaternary ammonium salt (chloride or sulphate), 2-(diethylamino)ethyl (meth)acrylate quaternary ammonium salt (chloride or sulphate), 2-(dimethylamino)ethyl (meth)acrylamide quaternary ammonium salt (chloride or sulphate), 3-(dimethylamino)propyl (meth)acrylamide quaternary ammonium salt (chloride or sulphate).

Suitable (hydrophobic) monomers having a poor miscibility with water are: alkyl (meth)acrylates (e.g. ethyl acrylate, n-butyl acrylate, n-hexylacrylate, octylacrylate, laurylacrylate), aromatic acrylates (phenol acrylate, alkyl phenol acrylate, etc), hydroxypivalic acid, tricyclodecanedimethanol diacrylate), trimethylolpropane triacrylate, pentaerythritol triacrylate, pentaerythritol tetraacrylate, dipentaerythritol pentaacrylate, dipentaerythritol hexaacrylate, ditrimethyloipropane tetraacrylate, styrene derivatives, divinylbenzene, vinyl acetate, vinyl alkyl ethers, alkene, butadiene, norbonene, isoprene, polyester acrylates having alkyl chain longer than C₄, polyurethane acrylates having alkyl chain longer than C₄ and polyamide acrylates having alkyl chain longer than C₄.

Preferably no more than 30 wt % of the total monomers used to form the porous layer have a molecular mass (Mᵢ) above 600.

In order for the advertisement to perform well under night time conditions the ink receptive substrate preferably has a light transmittance of 10% to 45%, more preferably 12% to 35% and especially 13% to 25%. Light transmittance may be measured by, for example, an X-rite model 310 densitometer. Transmission is calculated by measuring the visual transmission Tᵥᵢₛ using the formula Tᵥᵢₛ=10^{-D}*100% wherein D is the visual transmission density response.

Preferably the ink receptive substrate scatters light which passes through it. In this way when the advertisement is lit from behind the detail of the light source (e.g. bulb or tube) does not detract from the advertisement.

For high quality images it is important for the ink receptive substrate to have a good whiteness. The whiteness can be defined in terms of its L*-value using the internationally recognised CIE 1976 (L*, a*, b*) colour space model. Under this model, an value of 0 is pure black and 100 is pure white.

Preferably the ink receptive substrate has an L*-value of at least 92.5, more preferably at least 92.9, especially at least 93.0. L*-values below 92.5 are usually unacceptable for use in advertisements intended to be viewed by reflected light e.g. in daylight, because unprinted parts of ink receptive substrates having low L-values are generally not as white as substrates with higher L-values. Preferably the L* value is less than 98.0, more preferably less than 97.0 when the ink receptive substrate is to be used as backlit film to have sufficient light transmittance when lit from behind. Thus L*-values of 92.5 to 98.0 and especially 92.9 to 97 are preferred to provide a good balance of whiteness and light transmittance. The L* value depends to some extent on the thickness of the porous layer: the thicker the porous layer the higher the L*-value. For monomers giving very high L*-values a thinner porous layer may be applied while for monomers giving relatively low L*-values a thicker porous layer may be more preferred.

Preferably at least 75%, more preferably at least 90% and especially at least 95% of the support layer is covered by the porous layer.

Preferably the porous layer contains less than 10 wt %, more preferably less than 5 wt %, especially less than 1 wt % of pigment. This preference arises because the pigment can reduce the transparency of the porous layer and adversely affect the brightness of the advertisement when lit from behind. Pigments that may be used include whitening pigments, for example aquamarine pigments.

Preferably the porous layer has a void volume of 10 to 80%, more preferably 20 to 55%.

In general the dry thickness of the porous layer is typically between 5 and 200 μm (μm means microns) more preferably between 10 and 100 μm. When adhered to the support the porous layer need not give internal strength and the optimal thickness is based on properties such as ink uptake capacity. When the porous layer has a multilayer structure the thickness of the various layers can be selected freely depending on the properties one wishes to achieve.

Preferably the majority of the pores of the porous layer have a size of between 0.05 and 3.0 μm, more preferably between 0.1 and 1.5 μm. The pore sizes may be determined using Scanning Electron Microscope images. For selected embodiments the average pore diameter preferably is between 0.2 and 2.0 μm, more preferably between 0.3 and 1.2 μm. There is no limitation as to the pore shape. The pores can for instance be spherical or irregular or a combination of both. Preferably the pores are inter-connected, since this will contribute to a quick ink absorption.

Preferably the porous layer exhibits no swelling when in contact with solvents from the ink, although a slight degree of swelling may be acceptable. The degree of swelling can be controlled by the types and ratio of monomers, the extent of curing/cross-linking (exposure dose, photo-initiator type and amount) and by other ingredients (e.g. chain transfer agents, synergists). It was found that the solvent uptake speed was negatively influenced when the porous layer exhibited swelling behaviour. Without wishing to be bound by theory, the researchers assume that due to swelling the actual pore size reduces thereby reducing the uptake speed of pigment particles and highly viscous inks.

The ink generally comprises a colorant and a liquid vehicle.

Preferably the colorant is a dye, a pigment or both a dye and a pigment. Dyes are preferred where high transparency, very bright coloured areas are required (due to the greater transparency, wider colour gamut and brightness of dyes) and where the advertisement will not be exposed to direct sunlight for long periods of time. Pigments are preferred where higher lightfastness is required and lower transparency can be tolerated. This is because pigments have a much lower tendency to fade in sunlight, but their particulate nature makes them less light transmissive, depending on the depth of shade being printed. One may also use inks containing both dye and pigment, or a combination of pigment-based inks and dye-based inks, in order to obtain the optimum combination of light fastness, brightness, transparency and colour gamut. For outdoor advertisements pigment inks are preferred.

Non-aqueous inks are preferred, especially when the ink receptive layer is hydrophobic.

Preferred inks include radiation curable inks and solvent-based inks. Radiation curable inks and solvent-based inks are available commercially from a number of sources, including for example from Fujifilm Sericol.

Suitable radiation curable inks typically comprise one or more polymerisable monomers as liquid vehicle, a photoinitiator and a colorant. Examples of such inks are provided in, for example, WO99/29787, EP-A-0540203, EP-A-0465039 and WO97/31071.

Suitable solvent-based inks comprise one or more organic solvents as liquid vehicle, a colorant and optionally a dispersant for the colorant. Examples of such inks are described in detail in U.S. Pat. No. 5,663,217, U.S. Pat. No. 5,112,398 and U.S. Pat. No. 5,010,125.

Where the ink is printed using an ink jet printer it preferably has a viscosity at the firing temperature of the printhead of not greater than 35 mPa·s.

The ink may be printed onto the ink receptive substrate by any of the known printing methods, including by contact and non-contact printing methods.

Preferred contact printing methods are letterpress printing and offset lithography printing. In letterpress printing ink is typically transferred from a plate to the ink receptive substrate involving direct contact. In typical offset lithography, thin, flexible metal plates are processed photographically and carry an image that is moistened and inked. The image is then transferred to a cylinder that reproduces it on the ink receptive substrate.

The preferred non-contact printing method is ink jet printing. In this method, an ink jet printer typically fires droplets of ink through a nozzle onto the ink receptive substrate without the nozzle and substrate coming into contact with each other. Preferred ink jet printers are piezoelectric ink jet printers, thermal ink jet printers and Memjet inkjet printers, e.g. as developed by Mr Kia Silverbrook. In thermal ink jet printers, programmed pulses of heat are applied to the ink in a reservoir by means of a resistor adjacent to an orifice in the nozzle, thereby causing the ink to be ejected in the form of small droplets directed towards the substrate. In piezoelectric ink jet printers the oscillation of a small crystal causes ejection of the ink from the nozzle onto the substrate.

The ink receptive substrate may be prepared by polymerising monomers (at least 30 wt % of which are alkylene glycol diacrylate(s) having an Mw below 500) under conditions which result in a porous layer being formed. Typically this involves phase separation, for example the monomers are mixed with a liquid medium in which they are miscible and polymerisation of the monomers creates species which are less miscible in the liquid medium and they separate from the liquid, creating a polymer network containing pores which are occupied by the then immiscible liquid medium. After removal of the liquid medium (e.g. by drying the polymerised monomers) these pores become available to receive ink.

If the monomers are too soluble in the liquid medium then no phase separation occurs and usually a gel structure may be formed after polymerization. Therefore one needs to select monomer and liquid medium combinations which give the desired porosity. This may be done by simple trial and error, selecting appropriate monomers from their known hydrophilicity/hydrophobicity together with water/organic solvent (i.e. liquid vehicle) combinations which match. Typically the monomer concentration in the liquid medium is between 10 and 80 wt %, more preferably between 20 and 70 wt %, most preferably between 30 and 50 wt %.

Monomers for which the miscibility of water in the monomer at 25° C. is 1.5 wt % to 50 wt % are preferred. More preferably the miscibility of water in the monomer at 25° C. is between 10 wt % and 30 wt. %. “Miscibility” in this context means that a stable mixture is obtained without phase separation phenomena. For example, a miscibility of water in the monomer of 15 wt % means that a mixture of water/monomer in the weight ratio 15/85 is stable.

Organic solvents that form part of the liquid medium are preferably water-miscible. Water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol; mono-C₁₋₄-alkyl ethers of diols, preferably mono-C₁₋₄-alkyl ethers of diols having 2 to 4 carbon atoms, especially 2-methoxyethanol, 2-(2-methoxyethoxy)ethanol and 2-(2-ethoxyethoxy)-ethanol; cyclic amides, preferably 2-pyrrolidone, N-methyl-2-pyrrolidone, N-ethyl-2-pyrrolidone, caprolactam and 1,3-dimethylimidazolidone; and cyclic esters, preferably caprolactone. Preferably the water-miscible organic solvent has a boiling point below 100° C. Examples of such solvents include alcohols, especially iso-propyl alcohol, which has been found to be particularly effective when mixed with water for producing the porous layer.

When the medium comprises a mixture of water and an organic solvent, the weight ratio of water to organic solvent is preferably from 99:1 to 1:99, more preferably from 90:10 to 30:70 and especially from 80:20 to 50:50.

Preferably the monomers form a clear solution in the liquid medium because clear solutions are usually very stable. However a slight turbidity is usually acceptable. On the other hand for phase separation to occur the growing polymer should be insoluble in the liquid medium. This puts certain restrictions to the monomers and monomer combinations that can be selected in combination with a particular liquid medium. Possible methods that can facilitate the selection of suitable combinations are described in e.g. EP-A-216622 (cloud point) and U.S. Pat. No. 3,823,027 (Hansen system).

To obtain a large difference in solubility between the monomer(s) and the resulting porous polymer and thus a fast phase separation, preferably the molecular weight (MW) of the monomers is not too large.

Typically one or more photo-initiators are used to assist polymerisation of the monomers, especially when the monomers are to be cured by UV or visible light radiation. Suitable photo-initiators are those known in the art such as radical type, cation type or anion type photo-initiators. Preferred photo-initiators are copolymerisable with the monomers.

Suitable photo-initiators include alpha-hydroxyalkylphenones, e.g. 2-hydroxy-2-methyl-1-phenyl propan-1-one, 2-hydroxy-2-methyl-1-(4-tert-butyl-) phenylpropan-1-one, 2-hydroxy-[4′-(2-hydroxypropoxy)phenyl]-2-methylpropan-1-one, 2-hydroxy-1-[4-(2-hydroxyethoxy)phenyl]-2-methyl propan-1-one, 1-hydroxycyclohexylphenylketone and oligo[2-hydroxy-2-methyl-1-{4-(1-methylvinyl)phenyl}propanone], alpha-aminoalkylphenones, alpha sulfonylalkylphenones and acylphosphine oxides such as 2,4,6-trimethylbenzoyl-diphenylphosphine oxide, ethyl-2,4,6-trimethylbenzoyl- phenylphosphinate and bis(2,4,6-trimethylbenzoyl)-phenylphosphine oxide.

Highly reactive photo-initiators such as ethyl (2,4,6-trimethylbenzoyl)phenyl phosphinate (Omnirad™ TPO-L), diphenyl-(2,4,6-trimethylbenzoyl)phosphine oxide (Additol™ TPO), 2,2-dimethoxy-2-phenylacetophenone (Additol™ BDK), Irgacure™ 1800, Irgacure™ 1870, phenylbis(2,4,6-trimethylbenzoyl)phosphine oxide 50% dispersion in water (Irgacure™ 819DW) and isoamyl(4-dimethylamino)benzoate (Chivacure™ IPK) are preferred. Preferably the ratio of photo-initiator to monomers is from 0.001 and 0.1, more preferably from 0.005 and 0.05, based on weight. It is preferred to minimize the amount of photo-initiator used, in other words preferably most photo-initiator has reacted after the curing step (or curing steps). This is because remaining photo-initiator may have adverse effects such as yellowing or degradation of dyes used in the eventual ink.

When the porous layer has a multilayer structure the type and concentration of photo-initiator can be chosen independently. For example, in a multilayer structure the photo-initiator in the top layer may be different from the photo-initiator in lower layer(s) which can give more efficient curing with low initiator concentrations than when a single initiator is applied throughout all layers. Some types of photo-initiator are most effective in curing the surface while other types cure much deeper into the layer when irradiated with radiation.

Thus in one embodiment the porous layer has multilayer structure comprising a top layer and lower layer(s) and the photoinitiator present in the top and lower layers are different from each other. The reference to photoinitiator present in these cured layers is to that part of the photoinitiators which remain after cure.

For the lower layer(s) a good through cure is important and for a high efficiency of curing it is preferred to select a photo-initiator that has an absorption spectrum not fully overlapping with the spectrum of the photo-initiator applied in the top layer. Preferably the difference in absorption maximum between photo-initiators in the top layer and in the bottom layer is at least 20 nm. When UV radiation is used a light source can be selected having emissions at several wavelengths. The combination of UV light source and photo-initiators can be optimized so that sufficient radiation penetrates to the lower layers to activate the photo-initiators. A typical example is an H-bulb with an output of 600 Watts/inch (240 W/cm) as supplied by Fusion UV Systems which has emission maxima around 220 nm, 255 nm, 300 nm, 310 nm, 365 nm, 405 nm, 435 nm, 550 nm and 580 nm. Alternatives are the V-bulb and the D-bulb which have a different emission spectrum. There needs to be sufficient overlap between the spectrum of the UV light source and that of the photo-initiators. This method allows for thicker layers to be cured efficiently with the same intensity of irradiation. Additionally by applying different types of photo-initiator characteristics such as scratch resistance and adhesion can be improved.

Curing rates may be increased by adding amine synergists to the monomers. Amine synergists are known to enhance reactivity and retard oxygen inhibition. Suitable amine synergists are e.g. free alkyl amines such as triethylamine, methyldiethanol amine, triethanol amine; aromatic amine such as 2-ethylhexyl-4-dimethylaminobenzoate, ethyl-4-dimethylaminobenzoate and also polymeric amines as polyallylamine and its derivatives. Curable amine synergists such as ethylenically unsaturated amines (e.g. acrylated amines such as CN3755, CN341, CN381 and CN386, all from Sartomer, France) are preferable since their use will give less odour, lower volatility and less yellowing due to its ability to be incorporated into the polymeric matrix by curing.

The amount of amine synergists is preferably from 0.1-10 wt % based on the amount of monomers in the curable composition, more preferably from 0.5-5 wt % based on the amount of curable compounds.

In principle (electromagnetic) radiation of any suitable wavelength can be used to cure the monomers, such as for example ultraviolet, visible or infrared radiation, as long as it matches the absorption spectrum of the photo-initiator, when present, or as long as enough energy is provided to directly cure the monomers without the need of a photo-initiator.

Curing by infrared radiation is also known as thermal curing. This may also be used, typically with a free radical initiator. Exemplary free radical initiators are organic peroxides such as ethyl peroxide and benzyl peroxide; hydroperoxides such as methyl hydroperoxide, acyloins such as benzoin; certain azo compounds such as [alpha], [alpha]′-azobisisobutyronitrile and [gamma], [gamma]′-azobis([gamma]-cyanovaleric acid); persulfates; peracetates such as methyl peracetate and tert-butyl peracetate; peroxalates such as dimethyl peroxalate and di(tert-butyl) peroxalate; disulfides such as dimethyl thiuram disulfide and ketone peroxides such as methyl ethyl ketone peroxide. Temperatures in the range of from about 23° C. to about 150° C. are generally employed. More often, temperatures in the range of from about 37° C. to about 110° C. are used. Irradiation by ultraviolet light is preferred. Suitable wavelengths are for instance UV-A (400-320 nm), UV-B (320-280 nm), UV-C (280-200 nm), provided the wavelength matches with the absorbing wavelength of the photo-initiator, if present.

Suitable sources of ultraviolet light are mercury arc lamps, carbon arc lamps, low pressure mercury lamps, medium pressure mercury lamps, high pressure mercury lamps, swirlflow plasma arc lamps, metal halide lamps, xenon lamps, tungsten lamps, halogen lamps, lasers and ultraviolet light emitting diodes. Particularly preferred are ultraviolet light emitting lamps of the medium or high pressure mercury vapour type. In addition, additives such as metal halides may be present to modify the emission spectrum of the lamp. In most cases lamps with emission maxima between 200 and 450 nm are most suitable.

The energy output of the light source may be between 20 and 240 W/cm, preferably between 40 and 150 W/cm, although it may be higher or lower as long as the desired exposure dose can be realised. The exposure intensity is one of the parameters that can be used to control the extent of curing which influences the final structure of the porous layer. Preferably the exposure dose is at least 40 mJ/cm², more preferably between 40 and 600 mJ/cm², most preferably between 70 and 220 mJ/cm² as measured by an High Energy UV Radiometer (UV Power Puck™ from EIT—Instrument Markets) in the UV-B range indicated by the apparatus. Exposure times can be chosen freely but need not be long and are typically less than 1 second.

When no photo-initiator is added, the curable compound can be advantageously cured by electron-beam exposure as is known in the art. Preferably the output is between 50 and 300 keV. Curing can also be achieved by plasma or corona exposure.

The pH of the monomer and liquid medium mixture is preferably 2 to 11, more preferably 3 to 8. The optimum pH depends on the used monomers and can be determined by routine experimentation. The curing rate appeared to be pH dependent: at high pH the curing rate is reduced resulting in a less porous layer. At low pH values (e.g. lower than 2) yellowing of the porous layer upon aging can occur.

Where desired, a surfactant or combination of surfactants may be added to the monomer and liquid medium mixture as a wetting agent to adjust surface tension. Commercially available surfactants may be utilized, including radiation-curable surfactants. Surfactants suitable for use in the curable mixture include nonionic surfactants, ionic surfactants, amphoteric surfactants and combinations thereof. Preferred surfactants are fluorine based or silicon based. Suitable fluorosurfactants are commercially available under the name Zonyl® (produced by E.I. Du Pont). Also useful are the fluorocarbon surfactants as described e.g. in US-A-4 781 985 and in US-A-5 084 340.

Silicon based surfactants are preferably polysiloxanes such as polysiloxane-polyoxyalkylene copolymers. Examples of polyether siloxane copolymers commercially available in the market include SILWET™ DA series, such as SILWET™ 408, 560 or 806, SILWET™ L series such as SILWET™-7602 or COATSIL™ series such as COATSIL™ 1211, manufactured by CK Witco; KF351A, KF353A, KF354A, KF618, KF945A, KF352A, KF615A, KF6008, KF6001, KF6013, KF6015, KF6016, KF6017, manufactured by Shin-Etsu; BYK-019, BYK-300, BYK-301, BYK-302, BYK-306, BYK-307, BYK-310, BYK-315, BYK-320, BYK-325, BYK-330, BYK-333, BYK-331, BYK-335, BYK-341, BYK-344, BYK-345, BYK-346, BYK-348, manufactured by Byk-Chemie; and GLIDE™ series such as GLIDE™ 450, FLOW™ series such as FLOW™ 425, WET™ series such as WET™ 265, manufactured by Tego.

If desired the membrane may be subjected to more than one curing step in order to enhance robustness of the cured layer, for example as described in WO 2007/018422, page 25, line 17 to page 26, line 28, which is incorporated herein by reference thereto. By coating the monomer and liquid medium mixture on a substrate, curing the coated mixture thereby causing phase separation between the crosslinked monomers and the solvent and applying a subsequent curing step (“re-curing”) a substrate provided with a porous layer of high internal strength is formed. The porous layer may be subjected to a washing and/or drying step. A re-curing treatment of the porous layer after drying is completed is more effective for enhancing the robustness than intensifying the curing of the wet coated layer. Without wishing to be bound by theory, this improvement in robustness may arise because drying causes the unreacted curable double bonds to move closer to each other, thereby increasing the probability of crosslinking upon curing. This re-curing step may be done by UV-curing, but also other methods are suitable such as EB-curing or curing using other sources of radiation. For re-curing to be effective at least part of the photo-initiator needs to remain in reactive form after the first curing step. On the other hand it is preferred that after the final cure step (whether there be one or more than one curing step) most or all of the photo-initiator has reacted because remaining photo-initiator may lead to undesirable yellowing of the porous layer. This can be easily achieved by tuning the initial concentration of the photo-initiator in the recipe. Alternatively additional photo-initiator for the re-curing(s) is added separately e.g. by impregnation.

Instead of re-curing the porous layer in the dry state the porous layer may be re-cured while being wet. One way of execution is to perform the re-curing shortly after the first curing without intermediate drying step. Another way is to rewet the dried layer by a liquid that may contain one or more ingredients such as surfactants. An advantage of this procedure is that in the wet state the layer structure changes upon curing when the layer is swellable in the liquid applied. So properties such as porosity can be modified by performing a re-curing step when the porous layer is in the swollen state. By this method a wider range of materials and process conditions become suitable since tuning of the structure remains possible after the initial curing step. An additional advantage is that the porous layer becomes more translucent to the (UV) radiation—depending on the liquid selected—thereby increasing the penetration into the layer because the layer scatters less light when the pores are filled with liquid than when they are filled with air. Also oxygen inhibition is often less.

In between curing steps an impregnation can be carried out. By impregnation compounds can be brought into the porous layer that are not very well compatible with the curable mixture of the first curing step. When it is desired to fix the compounds brought in by impregnation to the matrix a re-curing step is the preferred method of crosslinking. Preferably the porous layer is at least partly dried before an impregnation step is executed. By partial drying the compounds introduced by impregnation e.g. by coating, spraying or dipping, can deeper penetrate into the porous layer. By partial drying part of the solvent is removed, e.g. 25% or 50% and in some cases up to 80% of the solvent is removed prior to impregnation. With a good process design more than 2 curing steps will in general not result in improved properties, however certain circumstances such as limited UV intensity may make multiple curing beneficial.

Preferably the exposure dose in the second curing step is between 80 and 300 mJ/m², more preferably between 100 and 200 mJ/m². The exposure dose may be as measured by an High Energy UV Radiometer (UV Power Puck™ from EIT—Instrument Markets) in the UV-B range indicated by the apparatus.

The porous layer may also comprise one or more non-curable water soluble polymers and/or one or more hydrophilic polymers that are not crosslinked by exposure to radiation. The non-curable water soluble polymer may be added to the curable mixture before curing or applied to the cured porous layer after curing.

It may be desirable to add in the top layer a matting agent (also known as an anti-blocking agent) to reduce friction and to prevent image transfer when several printed advertisements are stacked. Very suitable matting agents have a particle size from 1 to 20 μm, preferably between 2 and 10 μm.

When desired mordants may be added to the curable mixture(s). Mordants are preferably added in the outer layer or layers e.g. in the top layer and/or in the layer just below the top layer in case the porous layer is a multilayer. Preferably the mordants are cationic, making them suitable to form complexes with anionic colorants. Organic and inorganic mordants may be employed alone independently or in combination with each other. A suitable method to fix the mordants in the (outer) layer is to introduce negative charges in the (outer) layer, for instance by including anionic monomers in the curable monomer mixture used to make the porous layer.

A cationic mordant described above is preferably a polymeric mordant having a primary to tertiary amino group or a quaternary ammonium salt as a cationic group; a cationic non-polymeric mordant may also be employed. Suitable mordant monomers are for example alkyl- or benzyl ammonium salts comprising one or more curable groups such as vinyl, (di)allyl, (meth)acrylate, (meth)acrylamide and (meth)acryloyl groups.

A non-mordant monomer as described above is a monomer which does not contain a basic or cationic moiety such as a primary to tertiary amino group or its salt, or quaternary ammonium salt and which exhibits no or substantially slight interaction with a dye contained in the ink jet printing ink.

The amount of mordant in the porous layer is preferably from 0.01 to 5 g/m², more preferably from 0.1 to 3 g/m². If the mordant is a relativity small molecule the mordant or the mordant-colorant complex may diffuse within the layer or to other layers causing reduced sharpness. This problem is also referred to as long term bleeding.

In a preferred embodiment the monomers include one or more copolymerisable cationic mordants. These cationic mordants help to fix anionic compounds (e.g. dyes and pigments carrying anionic groups) to the porous layer and reduce long term bleeding.

Other additives that may be added to the monomers include UV absorbing agents, brightening agents, anti-oxidants, light stabilising agents, radical scavengers, anti-blurring agents, antistatic agents and/or anionic, cationic, non-ionic, and/or amphoteric surfactants.

Suitable optical brighteners are disclosed in e.g. RD11125, RD9310, RD8727, RD8407, RD36544 and Ullmann's Encyclopedia of industrial chemistry (Vol. A18 p. 153-167). The amount of optical brightening agent is preferably lower than 1 g/m²; more preferably between 0.004 and 0.2 g/m²; most preferably between 0.01 and 0.1 g/m².

Further the porous layer may comprise one of more light stabilising agents such as sterically hindered phenols, sterically hindered amines, and compounds as disclosed in GB2088777, RD 30805, RD 30362 and RD 31980. Especially suitable are water-soluble substituted piperidinium compounds as disclosed in WO-A-02/55618 and compounds such as CGP-520 (Ciba Specialty Chemicals, Switzerland) and Chisorb 582-L (Double Bond Chemical, Taiwan).

Other additives may be one or more plasticizers, such as (poly)alkylene glycol, glycerol ethers and polymer lattices with low Tg-value such as polyethylacrylate, polymethylacrylate and the like. Also there may be included one or more of biocides, pH controllers, preservatives, viscosity modifiers, dispersing agents, inhibitors, anti-blurring agents, antifoam agents, anti-curling agents, whitening pigments, flame retardants and water resistance-imparting agents.

The porous layer may be produced by, for example, the following steps:
(a) providing a mixture comprising monomers and a liquid medium, at least 30 wt % of which monomers are alkylene glycol diacrylate(s) having an Mw below 500;
(b) applying said mixture to a transparent or translucent support layer;
(c) curing said monomers by exposure to radiation, thereby causing phase separation between the crosslinked monomers and the liquid medium;
(d) removing the liquid medium from the resulting porous layer; and
(e) optionally performing a second curing treatment.

A second curing treatment may increase the porosity, improve the scratch resistance and adhesion and reduce the amount of extractable compounds.

For applying the mixture to the support layer, various coating techniques may be used, for example, curtain coating, extrusion coating, air-knife coating, slide coating, roll coating method, reverse roll coating, dip coating or rod bar coating. In order to produce a sufficiently flowable mixture for use in a high speed coating machine, it is preferred that the viscosity of the mixture is below 4,000 mPa·s at 25° C., more preferably below 1,000 mPa·s at 25° C. With this technique coating speeds up to 50 m/min or even higher, such as 100 m/min or more, can be reached. To reach the desired dose more than one UV lamp in sequence may be required, so that the coated support is (successively) exposed to more than one lamp. When two or more lamps are applied all lamps may give an equal dose or each lamp may have an individual setting.

While it is possible to practice the invention on a batch basis with a stationary support surface, it is much preferred to practice it on a continuous basis using a moving support surface such as a transparent or translucent support resting on a roll-driven continuous web or belt.

Preferred transparent and translucent supports are composed of a polyester (e.g. polyethylene terephthalate (PET)), polyethylene naphthalate (PEN), triacetate cellulose (TAC), polysulfone, polyphenylene oxide, polyethylene, polypropylene, polyvinylchloride, polyimide, polycarbonate, polyamide, glass, polyacrylate, polymethylmethacrylate (PMMA) or the like. Inter alia, polyesters are preferable, and polyethylene terephthalate is particularly preferable.

The thickness of the transparent or translucent support is not particularly limited, however 50 to 300 μm is preferable from the viewpoint of easy handling.

Preferably the transparent or translucent support contains less than 10 wt %, more preferably less than 6 wt %, especially less than 1 wt % of pigment. This preference arises because the pigment can reduce the transparency of the support and adversely affect the brightness of the advertisement when lit from behind.

According to a further aspect of the present invention there is provided a process according to the present invention which further comprises the step of mounting the printed ink receptive substrate in a light box.

Preferably the light box comprises a frame defining a window and a light source. Preferably the printed ink receptive substrate is mounted onto two rollers such that an advertisement is visible through the window and the advertisement may be changed by rotating the rollers.

The invention also provides a light box comprising a frame defining a window, a light source and a printed substrate obtained by a process according to the present invention.

The invention is particularly useful for preparing advertisements for use in billboards and in display panels, e.g. in street furniture, in supermarkets and other public spaces. Examples of display panels include 6-Sheet, 48-Sheet and 96-Sheet panels. The advertisement is typically for promoting goods or services or for conveying information. The list of goods is endless, including perfumes, watches, vehicles, accommodation, apparel, food and drink. The list of services is also endless, including insurance, holidays, sports events, concerts, rentals and so forth. Information can be, for example, on social, welfare and/or public health issues.

Preferably the advertisement includes the colours yellow, magenta, cyan and black. Typically the advertisements comprises text, artwork and/or one or more pictures.

According to a further aspect of the present invention there is provided a porous sheet comprising polymerised monomers at least 30 wt % of which monomers are alkylene glycol diacrylate(s) having an Mw below 450.

Preferably the porous sheet comprises polymerised monomers at least 40 wt %, more preferably at least 50 wt %, especially at least 60 wt % and more especially at least 75 wt % of which are alkylene glycol diacrylate(s) having an Mw below 450. In one embodiment all of the monomers in the porous layer are alkylene glycol diacrylates having a molecular weight below 450 or, more preferably, below 400.

Other preferences (e.g. porosity, void volume, thickness and so forth) are as described above for the porous layer according to the first aspect of the present invention. The sheets may be prepared as described above for the porous layers, either with or without a transparent or translucent support.

These sheet materials may be used in the process of the present invention or for other purposes if desired, e.g. as membranes for water treatment, in the chemical and petrochemical industry, for ultra filtration processes in the electrocoating of paint, in the food industry such as in the production process of cheese, clarification of fruit juice and in the beer production, in the pharmaceutical industry where a high resistivity membrane for organic solvents is required, and in the biotechnology industry especially where flux reduction due to fouling by protein needs to be avoided. The sheet materials can be made suitable for nanofiltration or reversed osmosis by selecting appropriate ingredients and process conditions.

The invention is now illustrated by the following non-limiting examples in which all parts and percentages are by weight unless otherwise specified. (“Comp” means Comparative).

### EXAMPLES 1 TO 17 AND COMPARATIVE EXAMPLES 1 TO 13

### (a) Providing a Mixture Comprising Monomers and a Liquid Medium

Mixtures comprising the components shown in Table 1 below were prepared. The Monomers used are as shown in Tables 2 to 5 below. The liquid media were mixtures of purified water (PW) and isopropyl alcohol (IPA) in the weight ratio shown in Tables 2 to 5 below. The photo-initiator was Irgacure™ 1800 (ex-CIBA) and the surfactant was a 3 wt % solution of Zonyl™ FSN-100 (ex-Dupont) in water.

TABLE 1

| Component | Amount (g) |
|---|---|
| Monomer | 18.8 |
| Liquid Medium | 26.0 |
| photo-initiator | 0.2 |
| Surfactant | 5.0 |
| Total | 50.0 |

### Measurement of Weight Average Molecular Weight (Mw)

The Mw of commercial products (i.e. monomer samples under investigation) were determined by the following general method.

The commercial product under investigation was dissolved in methanol to a concentration of 0.1 mg/L. The resultant monomer solution was then injected in a methanol carrier (flow injection). The mass of the repeating unit n and the molecular mass M of each component was determined using a Waters™ Acquity Ultra Performance Liquid Chromatography system and Waters™ Q-TOF Premier Mass Spectrometer.

The settings for the Waters™ Acquity Ultra Performance Liquid Chromatography system were as follows:

Run Time: 3.00 min (180 sec)

### Solvent: Methanol

Flow: 0.2 ml/min (3.33 μl/sec)

### Injection Volume 5.00 μl

The settings for the Waters™ Q-TOF Premier Mass Spectrometer were as follows:

| Polarity | ES+ | |
|---|---|---|
| Analyser | W Mode | |
| Capillary | 3.0 | kV |
| Sampling Cone | 35.0 | V |
| Extraction Cone | 5.0 | V |
| Ion Guide | 2.0 | V |
| Source Temperature | 120° | C. |
| Desolvation Temperature | 250° | C. |
| Cone Gas Flow | 50.0 L/hr (13.88 ml/sec) | |
| Desolvation Gas Flow | 800.0 L/hr (222.22 ml/sec) | |
| Collision Energy | 5.0 | V |

### Function Parameters—Function 1—TOF MS FUNCTION

| | | |
|---|---|---|
| Scan Time | 0.180 | sec |
| Interscan Time | 0.020 | sec |
| Start Mass | 80.0 | m/z |
| End Mass | 2000.0 | m/z |
| Start Time | 0.00 | sec |
| End Time | 180 | sec |

| | |
|---|---|
| Data Format | Centroid |

The samples were analysed by flow injection analysis; the solution is injected into a methanol carrier which is infused into the Q-TOF ionisation source. Because many of the investigated components are oligomers which do not show a distinctive mass but a mass distribution, first the mass of the repeating unit is determined. Subsequently the presence of adduct-ions (e.g. sodium, potassium, ammonium, others) is investigated. At this stage all ions from the mass distribution of this specific oligomer are known. Since the sodium adduct has the highest response factor, this adduct-mass is used for Mw calculation.

The Mw is calculated as follows:

Mw=ΣnᵢMᵢ²/ΣnᵢMᵢ

where

Mᵢ=Mass (Da) of peak i in the distribution

nᵢ=Area (counts per second) of Mass peak Mᵢ

The relative amount is expressed by summation of all sodium adduct ion intensities for the main component or impurity and divided by the total sodium adduct ion intensity.

Tᵥᵢₛ is the transmission (%) calculated by measuring the visual transmission density response D with an X-rite model 310 densitometer, using the formula Tᵥᵢₛ=10^{-D}*100%

The results of these LC-MS analyses and calculations are shown as Mw figures in the tables below.

TABLE 2
(Alkylene glycol diacrylates having an Mw below 500)

| | | Liquid | | | |
|---|---|---|---|---|---|
| | | Medium | | | |
| | | (wt | | L*- | Tᵥᵢₛ |
| Example | Monomer(s) | PW/IPA) | Mw | value | (%) |
| 1 | Ethylene glycol diacrylate, from | 10.2/15.8 | 170* | 95.0 | 16.9 |
| | Sigma Aldrich | | | | |
| 2 | Tri(ethylene glycol) diacrylate, | 14.0/12.0 | 259 | 92.9 | 23.0 |
| | SR272 from Sartomer | | | | |
| 3 | Tetra(ethylene glycol) diacrylate, | 19.0/7.0 | 304 | 93.6 | 21.0 |
| | from Sigma Aldrich | | | | |
| 4 | PEG 200 diacrylate, SR259, from | 19.0/7.0 | 468 | 93.9 | 20.0 |
| | Sartomer | | | | |
| 5 | Di(propylene glycol) diacrylate, | 8.0/18.0 | 243 | 93.4 | 21.4 |
| | SR508, from Sartomer | | | | |
| 6 | Tri(propylene glycol) diacrylate | 8.0/18.0 | 300 | 93.0 | 22.8 |
| | (mixture), from Sigma Aldrich | | | | |
| 7 | Poly(tetramethylene glycol) | 7.2/19.8 | 420 | 92.5 | 24.3 |
| | diacrylate, PTMGA-250, from | | | | |
| | Kyoeisha Chemical | | | | |
| 8 | Hexanediol diacrylate (from | 6.5/19.5 | 226* | 96.2 | 13.3 |
| | Sigma Aldrich) | | | | |
| 9 | SR259/hexanediol diacrylate = | 11.5/14.5 | 468/226* | 94.4 | 18.8 |
| | 50/50 weight ratio | | | | |
| 10 | SR259/CN435(ethoxylated (15 | 20.0/6.0 | 468/956* | 93.0 | 22.5 |
| | mole) trimethylolpropane | | | | |
| | triacrylate from Sartomer) = 70/30 | | | | |
| | weight ratio | | | | |
| 11 | SR259/CN132 (aliphatic | 19.0/7.0 | 468/800* | 92.7 | 24.0 |
| | diglycerolate diacrylate from | | | | |
| | Sartomer) = 66/34 weight ratio | | | | |
| 12 | CN3755/SR259/DA314 = | 17.5/8.5 | —/468/476* | 93.3 | 22.3 |
| | 4.8/68.6/26.6 weight ratio | | | | |
| 13 | CN3755/SR259/DA314 = | 17.5/8.5 | —/468/476* | 93.8 | 20.3 |
| | 4.8/55.3/39.9 weight ratio | | | | |
| 14 | CN3755/SR259/DA314 = | 17.5/8.5 | —/468/476* | 93.5 | 21.6 |
| | 4.8/42.0/53.2 weight ratio | | | | |
| 15 | CN3755/SR259/SR355 = | 14.5/11.5 | —/468/482* | 93.8 | 20.5 |
| | 4.8/81.9/13.3 weight ratio | | | | |
| 16 | CN3755/SR259/SR494 = | 16.5/9.5 | —/468/528* | 94.6 | 18.0 |
| | 4.8/81.9/13.3 weight ratio | | | | |
| 17 | CN3755/SR259/SR494 = | 14.0/12.0 | —/468/528* | 93.4 | 21.6 |
| | 4.8/68.8/26.6 weight ratio | | | | |

*means Mw is calculated or taken from literature
— means Mw not known
CN3755 is an acrylated amine synergist from Sartomer
SR355 is di-trimethylolpropane tetra acrylate from Sartomer
DA314 is Glycerol triglycerolate triacrylate from Nagase
SR494 is Ethoxylated (4) pentaerythritol tetraacrylate from Sartomer

TABLE 3
Comparative Examples (Diacrylates MW > 500)

| | | Liquid | | |
|---|---|---|---|---|
| | | Medium | | |
| Comp | | (wt | | L*- |
| Example | Monomer | PW/IPA) | Mw | value |
| Comp 1 | PEG 600 diacrylate, SR610, from | 19.0/7.0 | 744 | <80 |
| | Sartomer | | | |
| Comp 2 | PEG 400 diacrylate, SR344, from | 19.0/7.0 | 596 | 74.2 |
| | Sartomer | | | |
| Comp 3 | Poly(propylene glycol) diacrylate | 8.0/18.0 | 548 | <80 |
| | “MW = 540”, from Sigma Aldrich | | | |
| Comp 4 | Poly(propylene glycol) diacrylate | 8.0/18.0 | 900* | <80 |
| | “MW = 900”, from Sigma Aldrich | | | |
| Comp 5 | Ethoxylated (10) bisphenol-A | 8.5/17.5 | 756* | <80 |
| | diacrylate, SR602, from Sartomer | | | |
| Comp 6 | CN132 (aliphatic diglycerolate | 18.5/7.5 | 800* | 92.1 |
| | diacrylate from Sartomer) | | | |

*means Mw is calculated or taken from literature

TABLE 4
Comparative Examples (Tri- and Tetra- acrylate monomers)

| | | Liquid | | |
|---|---|---|---|---|
| | | Medium | | |
| Comp | | (wt | | L*- |
| Example | Monomer | PW/IPA) | Mw | value |
| Comp 7 | Glycerol triglycerolate tri- | 17.0/9.0 | 476* | 87.3 |
| | acrylate, DA314, Nagase | | | |
| Comp 8 | Glycerol triglycerolate tri- | 15.0/11.0 | 476* | 84.4 |
| | acrylate, DA314, Nagase, | | | |
| | 95.2 wt % + 4.8 wt % | | | |
| | CN3755) | | | |
| Comp 9 | Ethoxylated (3) trimethylolpropane | 8.0/18.0 | 428* | 91.2 |
| | triacrylate, SR454, Sartomer | | | |
| Comp 10 | Ethoxylated (9) trimethylolpropane | 16.5/9.5 | 692* | 91.6 |
| | triacrylate, SR502, Sartomer | | | |
| Comp 11 | Ethoxylated (4) pentaerythritol | 9.5/16.5 | 528* | 89.6 |
| | tetraacrylate, SR494, Sartomer | | | |

*means Mw is calculated or taken from literature

TABLE 5
Comparative Examples (<30% alkylene glycol
diacrylate(s) having an Mw below 500).

| | | Liquid | | |
|---|---|---|---|---|
| | | Medium | | |
| Comp | | (wt | | L*- |
| Example | Monomers | PW/IPA) | Mw | value |
| Comp 12 | CN3755/SR259/DA314 = | 17.5/8.5 | —/468/476* | 92.4 |
| | 4.8/28.7/66.5 | | | |
| Comp 13 | CN3755/SR259/DA314 = | 17.5/8.5 | —/468/476* | 92.0 |
| | 4.8/15.4/79.8 | | | |

*means Mw is calculated or taken from literature
— means Mw not known

### (b) Applying the Mixture to a Transparent or Translucent Support Layer;

The mixtures were applied to a PET (polyethylene terephthalate) sheet of 100 micrometer thickness as a transparent support using a bar coater type 60, resulting in a layer with a wet thickness of about 60 μm.

### (c) Curing the Monomers by Exposure to Radiation

The product of step (b) was fed underneath a UV-light emitting lamp (Light-Hammer™ 6 fitted in a bench-top conveyer LC6E, both supplied by Fusion UV) at room temperature, at a speed of 30 m/min at a power level of 100%. The time between coating and curing was kept within 30 sec. As the monomers polymerised in most cases a phase change occurred and the growing polymer separated out from the liquid medium. The liquid medium was removed from the resulting porous layer by drying at 40° C. for 20 minutes to give an ink receptive substrate. After rewetting with a 0.09% aqueous solution of Zonyl™ FSN-100 the porous sheet was exposed to a second curing treatment in the same apparatus with the same settings, followed by drying at 40° C. for 20 minutes.

### (d) Measurement of Whiteness (L*-Value)

The whiteness of each ink receptive substrate mentioned in Tables 2 to 6 was measured using a Minolta CM1000 spectrophotometer (settings: color measurement, display mode normal, L*a*b* color space, 10° observer angle, illuminant D65, trace wavelength 450 nm, average of 5 measurements). The results are shown in Table 2 to 6 above. In the L*-value column, higher numbers indicate higher whiteness/more reflected light. The minimum acceptable L*-value was 92.5.

### (e) Measurement of Transparency

The transparency (Tᵥᵢₛ) of each ink receptive substrate mentioned in Table 2 was measured using an X-rite model 310 densitometer using the formula Tᵥᵢₛ=10^{-D}*100% where D is the visual transmission density response.

### (f) Printing and Advertisement

An advertisement was printed onto the ink receptive substrate resulting from step (c) using a Mutoh Spitfire 100 extreme ink jet printer charged with inks from FUJIFILM Sericol (ink set KH). The printer settings were: Color: CMYK 44, Resolution: 720*720, Temperature: 35° C. The print quality was optimised by profiling according standard procedures. Visual evaluation of the prints derived from the ink receptive substrates prepared as described in the above Examples was as shown in Table 6:

TABLE 6

| Example | L-value | Whiteness | Print quality |
|---|---|---|---|
| Ex. 2 | 92.9 | ◯/Δ | ◯ |
| Ex. 4 | 93.9 | ◯ | ◯ |
| Ex. 9 | 94.4 | ◯ | ◯ |
| Comp. Ex. 7 | 87.3 | X | X |
| Comp. Ex. 6 | 92.1 | X/Δ | Δ |

◯ means good
Δ means almost acceptable (whiteness critical or balance between reflection and transmission density not good enough)
X means not acceptable (whiteness too greyish or too low drying speed resulting in coalescence of the ink)

### EXAMPLES 18 TO 20

### Multiple Porous Layers

### (a) Providing Mixtures Comprising Monomers and a Liquid Medium

Mixtures comprising the components shown in Table 7 below were prepared, where “Top” indicates the composition to be applied to the support as a top layer and “Bottom” indicates the composition to be applied to the support as a bottom layer.

TABLE 7

| | Example 18 | | Example 19 | | Example 20 | |
|---|---|---|---|---|---|---|
| | Top | Bottom | Top | Bottom | Top | Bottom |
| Component | (g) | (g) | (g) | (g) | (g) | (g) |
| SR-259 | 218.9 | 218.8 | 218.9 | 218.8 | 218.9 | 218.8 |
| Isopropanol | 94.3 | 103.2 | 94.3 | 103.2 | 94.3 | 103.2 |
| Water | 201.1 | 256.5 | 201.1 | 256.5 | 201.1 | 256.5 |
| Irgacure ™ | 4.13 | 4.07 | 4.13 | 0 | 0 | 0 |
| 184 | | | | | | |
| TPO-L | 0 | 0 | 0 | 4.07 | 4.13 | 4.07 |
| Surfactant | 75 | 0 | 75 | 0 | 75 | 0 |

Notes:
In Table 7 the surfactant was a 3 wt % solution of Zonyl ™ FSN-100 (ex-Dupont) in water; SR-259 is the curable monomer polyethylene glycol 200 diacrylate; Irgacure ™ 184 is 1-hydroxy-cyclohexyl-phenyl-ketone, a photo-initiator from Ciba; and TPO-L is ethyl-2,4,6-trimethylbenzoylphenylphosphinate, a photo-initiator from IGM Resins.

### (b) Applying the Mixtures to a Transparent Support Layer;

The mixtures described in Table 7 were applied to a transparent PET (polyethylene terephthalate) support layer using a slide bar coater having a lower slot (nearer to the support layer) and an upper slot (further away from the support layer). The mixture for the lower porous layer passed through the lower slot at a flow rate of 90 ml/m² and the mixture for the upper porous layer passed through the upper slot at a flow rate of 15 ml/m².

### (c) First Curing of the Monomers by Exposure to Radiation

Four seconds after the mixtures had been applied in step (b), the coated PET support layer was fed underneath a UV-light emitting lamp (Light-Hammer™ 6 from Fusion UV Systems), fitted with a D-bulb at 67% lamp intensity. This caused the mixtures to cure and the cured samples were dried for 3 minutes at 40° C. and 8% relative humidity,

### (d) Rewetting and Second Cure

A rewetting composition comprising a dilute surfactant (3% strength Zonyl™ FSN-100 (184.7 g) in water (1965.3 g)) was applied to the product of step (c) using a slide bead coater at a flow rate of 70 ml/m². The wetted sheet was then irradiated once again using the same apparatus as described in step (c) except with 100% lamp intensity. The resultant sheet was then dried to give an ink receptive substrate comprises a transparent support layer and a porous layer comprising polymerised monomers at least 30 wt % of which monomers are alkylene glycol diacrylate(s) having an Mw below 500.

### (e) Scratch Resistance Test

The scratch resistance of the ink receptive substrate prepared in step (d) was measured using a ‘Scratching Intensity Tester Heidon 18’ from Heidon Co, Japan. A stainless steel needle with a tip diameter of 0.1 mm was placed on the sample under test and a weight was placed on the needle. The sample was moved at a speed of 10 mm/sec while the weighted needle was resting on the sample. The process was repeated with increasing weights. The scratch resistance was the weight at which the cured, porous layer was substantially removed from the PET support by the needle and the underlying PET transparent sheet became visible. At lower weights a slight surface scratch in the porous layer was visible in some cases.

The results were as shown in Table 8:

TABLE 8

| Example | Scratch (g) |
|---|---|
| 18 (1 photo-initiator) | 50 |
| 19 (2 photo-initiators) | 70 |
| 20 (1 photo-initiator) | 60 |

### (f) Internal Scott Bond Test (Adhesion Test)

An L&W ZD Tensile Tester from Lorentzen & Wettre, Sweden fitted with double-sided self-adhesive (as supplied with the apparatus) was used to measure the strength of adhesion between the porous layers and the PET substrate. The settings on this apparatus were as follows:

| Standard | SCAN | |
|---|---|---|
| Thickness | 160 | μm |
| Grammage | 160.0 | g/m2 |
| Load rate | HIGH | |
| Test piece length | 300 | mm |
| Measurements per test piece | 3 | |
| Number of test pieces | 1 | |
| Measurement interval | 70 | mm |
| Measurement area | 10.0 | cm2 |
| Compression force | 3000 | N |
| Lower ZD strength limit | 500 | kPa |
| Upper ZD strength limit | 1200 | kPa |
| Compression time | 30 | sec |

Each of the ink receptive substrates arising from Examples 18 to 20 were cut into samples of size 300 mm×100 mm. The samples were then loaded onto the double-sided self-adhesive tape in the L&W ZD Tensile Tester.

Measurements were then started and data was generated automatically. The average adhesion strength across three samples were as shown in Table 9 where the higher kPa indicates better adhesion strength:

TABLE 9

| Example | Average (kPa) |
|---|---|
| 18 (1 photo-initiator) | 468 |
| 19 (2 photo-initiators) | 510 |
| 20 (1 photo-initiator) | 506 |

1. A process for preparing an advertisement comprising printing an ink onto an ink receptive substrate, wherein the ink receptive substrate comprises a transparent or translucent support layer and a porous layer comprising polymerised monomers at least 30 wt % of which monomers are alkylene glycol diacrylate(s) having an Mw below 500.

2. A process according to claim 1 wherein the at least 30 wt % of the alkylene glycol diacrylate(s) having an Mw below 500 are of Formula (I): 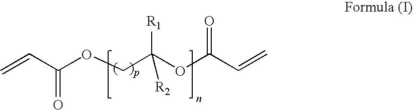
wherein:
each p independently is 1 to 5;
n is 1 to 8; and
each R₁ and R₂ independently is H, methyl or ethyl.

3. A process according to claim 1 wherein at least 50 wt % of the monomers are alkylene glycol diacrylate(s) having an Mw below 500.

4. A process according to claim 1 wherein at least 50 wt % of the monomers are alkylene glycol diacrylate(s) having an Mw below 450.

5. A process according to claim 1 wherein the ink receptive substrate has a light transmittance of between 10% and 45%.

6. A process according claim 1 wherein the ink receptive substrate has an L*-value of at least 92.5.

7. A process according to claim 1 wherein the ink is a radiation curable ink or a solvent-based ink.

8. A process according to claim 1 wherein the ink is a non-aqueous ink.

9. A process according to claim 1 wherein the printing is performed by an ink jet printer.

10. A process according to claim 1 which further comprises the step of mounting the printed ink receptive substrate in a light box.

11. A process according to claim 10 wherein the light box comprises a frame defining a window and a light source.

12. A process according to claim 11 wherein the printed ink receptive substrate is mounted onto two rollers such that an advertisement is visible through the window and the advertisement may be changed by rotating the rollers.

13. A process according to claim 1 wherein the porous layer has multilayer structure comprising a top layer and lower layer(s) and the photoinitiator present in the top and lower layers are different from each other.

14. (canceled)

15. (canceled)

16. A porous sheet comprising polymerised monomers at least 30 wt % of which monomers are alkylene glycol diacrylate(s) having an Mw below 450 and wherein the porous layer has multilayer structure comprising a top layer and lower layer(s) and the photoinitiator present in the top and lower layers are different from each other.

17. A light box comprising a frame defining a window, a light source and an advertisement comprising a printed ink receptive substrate, wherein the ink receptive substrate comprises a transparent or translucent support layer and a porous layer comprising polymerised monomers at least 30 wt % of which monomers are alkylene glycol diacrylate(s) having an Mw below 500.

18. A light box according to claim 17 wherein the porous layer has multilayer structure comprising a top layer and lower layer(s) and the photoinitiator present in the top and lower layers are different from each other.

19. A process according to claim 4 wherein the printing is performed by an ink jet printer.

20. A process according to claim 1 wherein at least 50 wt % of the monomers are alkylene glycol diacrylate(s) having an Mw below 500 and the ink receptive substrate has a light transmittance of between 10% and 45% and an L*-value of at least 92.5.

21. A process according to claim 20 wherein the printing is performed in an ink jet printer.

22. A light box according to claim 18 wherein at least 50 wt % of the monomers are alkylene glycol diacrylate(s) having an Mw below 500.
